(19) United States
(12) Patent Application Publication
(10) Pub. No.: US 2025/0213421 A1
(43) Pub. Date: Jul. 3, 2025

(54) MODULAR SEXUAL STIMULATION DEVICE

(71) Applicant: MysteryVibe Limited, Surrey (GB)

(72) Inventors: Soumyadip RAKSHIT, Haslemere (GB); Robert Paul WEEKLY, London (GB); Shanshan XU, London (GB); David Ian HEYWOOD, Surrey (GB)

(73) Assignee: MysteryVibe Limited, Surrey (GB)

(21) Appl. No.: 18/853,608

(22) PCT Filed: May 4, 2023
(86) PCT No.: PCT/IB2023/054658

§ 371 Date: Oct. 2, 2024

Related U.S. Application Data
(60) Provisional application No. 63/339,883, filed on May 9, 2022.

(51) Int. Cl. A61H 19/00; A61H 7/00; A61H 23/00; A61H 23/02

(52) U.S. Cl. CPC A61H 19/00; A61H 7/005; A61H 23/006; A61H 23/02; A61H 2201/0107; A61H 2201/0111; A61H 2201/0153; A61H 2201/0207; A61H 2201/10; A61H 2201/1207; A61H 2201/5015; A61H 2201/5025; A61H 2201/5035; A61H 2201/5097

(57) ABSTRACT

Modular sexual stimulation devices or sexual stimulation devices according to various embodiments are provided. The modular sexual stimulation device includes a handle and at least one replaceable/detachable stimulation head. The handle is configured to receive the at least one stimulation head. In some embodiments, the modular sexual stimulation device includes a handle enclosing at least a rechargeable battery and a first stimulation head configured to be detached from or coupled to the handle. The first stimulation head encloses a first stimulation component powered by the battery. In some embodiments, the modular sexual stimulation device further includes a second stimulation head configured to be detached from or coupled to the handle such that the first stimulation head can be replaced with the second stimulation head enclosing a second stimulation component powered by the battery. Each of the first and second stimulation components includes a vibration and/or suction motor.

### CROSS-REFERENCE TO RELATED APPLICATIONS

This application includes a claim of priority under 35 U.S.C. § 119(e) to U.S. provisional patent application No. 63/339,883, filed May 9, 2022, the entirety of which is hereby incorporated by reference.

### FIELD OF INVENTION

The present invention relates to a modular sexual stimulation device with a detachable handle and multiple stimulation head attachments.

### BACKGROUND

Sexual stimulation devices are a rapidly growing market. They are increasingly being used to address major sexual health issues. Sexual stimulation devices need to be high quality and body-safe. However, the majority of devices in this market are low in quality and often not body-safe. A reason behind this is that premium Sexual stimulation devices have high manufacturing costs leading to high consumer prices.

Therefore, there is a large unmet need to provide safer, more advanced, and more affordable Sexual stimulation devices. Described herein is a rechargeable modular Sexual stimulation device that is waterproof and made of body-safe materials, offering remote control and Bluetooth App control capability. The device also has high quality stimulation components such as vibration or suction motors.

### SUMMARY OF THE INVENTION

The present disclosure provides a modular sexual stimulation device. According to various embodiments of the present invention, the modular sexual stimulation device includes a handle and at least one replaceable/detachable stimulation head. The handle is configured to receive the at least one stimulation head.

In some embodiments, the at least one stimulation head is asymmetrically shaped and configured to be coupled to the handle in at least two different orientations such that the at least one stimulation head points toward a different direction based on a coupling orientation.

In some embodiments, the handle includes a built-in battery. In some embodiments, the handle further includes a port coupled to the battery. In some embodiments, the port is configured to receive a cable configured to be coupled to an electrical power outlet such that the battery can be recharged.

In some embodiments, the handle includes at least one control button. In some embodiments, the at least one control button is used for controlling at least one of power on/off of the device, stimulation pattern navigation, intensity adjustment, or BLUETOOTH® pairing with an external device. In some embodiments, the device is configured to provide various preset stimulation patterns such that a user can select a desired one of the preset stimulation patterns via the at least one control button. In some embodiments, the preset stimulation patterns are programmable by the user.

In some embodiments, the device is controllable via an application running on a mobile device that is configured to communicate with the device wirelessly.

In some embodiments, the device is waterproof by having a waterproof and shock-absorbing connection mechanism for coupling the at least one stimulation head to the handle.

In some embodiments, the at least one stimulation head includes at least two different types of stimulation heads such that the handle can be coupled to any one of the at least two different types of stimulation heads. In some embodiments, each of the at least two different types of stimulation heads has its own stimulation component. In some embodiments, the stimulation component is powered by a battery enclosed in the handle and includes one or more of a vibration and/or suction motor, a thrusting component, a warming component, and an electro-stimulation component.

In some embodiments, the device further includes a remote control module configured to control at least one of power on/off of the device, stimulation pattern navigation, or intensity adjustment.

The present disclosure also provides a modular sexual stimulation device. According to various embodiments of the present invention, the modular sexual stimulation device includes a handle enclosing at least a rechargeable battery; and a first stimulation head configured to be detached from or coupled to the handle. The first stimulation head encloses a first vibration and/or suction motor and/or one or more components capable of causing thrusting, warming, and/or electro-stimulation that is powered by the battery.

In some embodiments, the device further includes a second stimulation head configured to be detached from or coupled to the handle such that the first stimulation head can be replaced with the second stimulation head.

In some embodiments, the second stimulation head encloses a second vibration and/or suction motor and/or one or more components capable of causing thrusting, warming, and/or electro-stimulation that is powered by the battery.

In some embodiments, each of the first stimulation head and the second stimulation head has a different shape and configured to stimulate a different sexual organ of a user or subject.

In some embodiments, the device further includes a control button for controlling the first stimulation head and the second stimulation head. In some embodiments, the device can be powered on in response to user input received via the control button, a remote control module, or an application installed at an external device only when the first stimulation head or the second stimulation head is coupled to the handle.

### BRIEF DESCRIPTION OF THE FIGURES

Exemplary embodiments are illustrated in referenced figures. It is intended that the embodiments and figures disclosed herein are to be considered illustrative rather than restrictive.

FIGS. 1A, 1B, 1C, and 1D show a modular Sexual stimulation device with various stimulation heads attached in accordance with various embodiments of the present invention.

FIG. 2 shows a handle of a modular Sexual stimulation device in accordance with various embodiments of the present invention.

FIGS. 3A, 3B, 3C, and 3D show various types of stimulation heads of a modular Sexual stimulation device in accordance with various embodiments of the present invention.

FIGS. 4A, 4B, and 4C show various control mechanisms for controlling a modular Sexual stimulation device in accordance with various embodiments of the present invention.

FIGS. 5A, 5B, and 5C show a connection mechanism for a modular Sexual stimulation device in accordance with various embodiments of the present invention.

FIGS. 6A and 6B show a modular Sexual stimulation device with a stimulation head attached in different positions in accordance with various embodiments of the present invention.

FIGS. 7A and 7B show a modular Sexual stimulation device with a stimulation head to be attached in different positions in accordance with various embodiments of the present invention.

FIGS. 8A and 8B show a modular Sexual stimulation device with a stimulation head attached in different positions in accordance with various embodiments of the present invention.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The underlying reasons behind the significant difference in quality and functionality between the premium and low-cost Sexual stimulation devices are: cost of electronics (components, motors and battery), cost of the materials (plastics, silicone), and cost of regulatory compliance. In order to solve this problem, the device disclosed herein is designed in a modular way where the expensive electronics and compliance costs sits with the core module, the handle, which is reusable with all the other modules and can be manufactured cost effectively due to economies of scale. One where the core module which houses the most expensive components and costs the most to get to market (including compliance costs), can be reused with all the other modules, bringing the overall costs down through economies of scale.

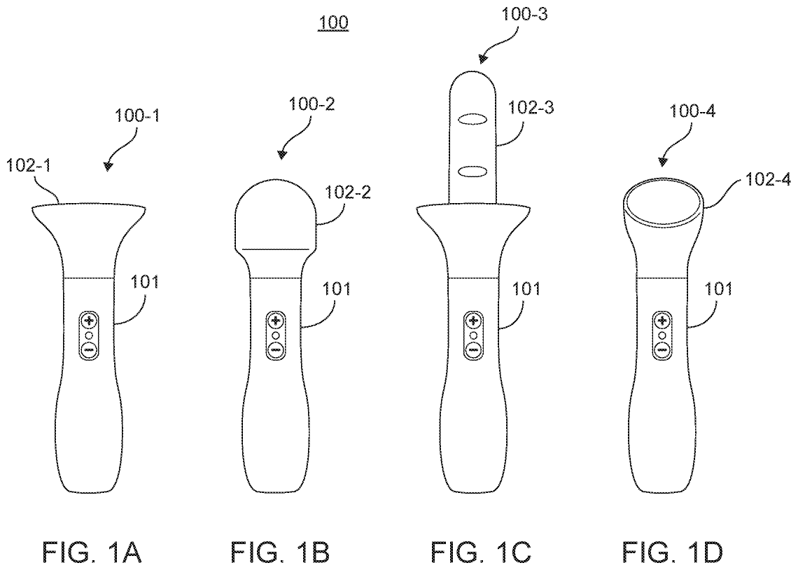

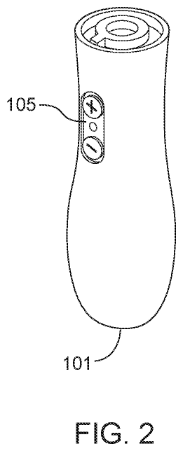

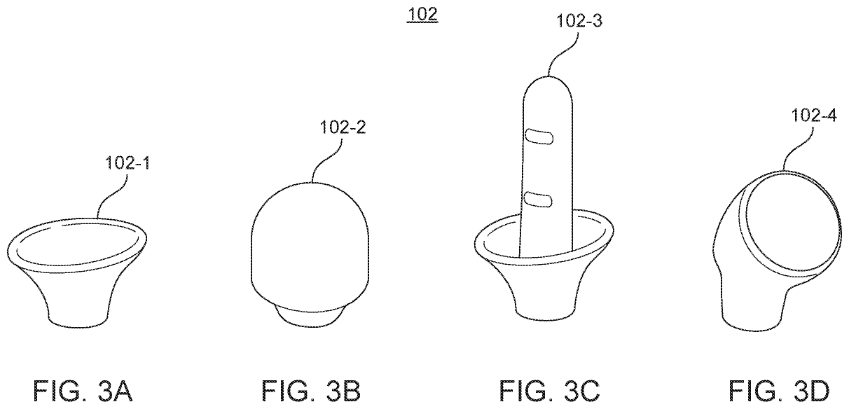

The various embodiments are directed to a modular Sexual stimulation device 100 or sexual stimulation device, exemplified in FIGS. 1A-1D. Referring to FIGS. 1A-3D and 6A-8B, in some embodiments, the Sexual stimulation device 100 includes a handle 101 coupled to various modules, i.e., stimulation heads 102. The handle 101 shown in FIG. 2 can be coupled to any of the various stimulation heads 102-1, 102-2, 102-3, 102-4 exemplified in FIGS. 3A, 3B, 3C, and 3D, respectively, to be assembled into different types of Sexual stimulation devices 100-1, 100-2, 100-3, 100-4 shown in FIGS. 1A, 1B, 1C, and 1D, respectively. For example, referring to FIGS. 1A and 3A, the Sexual stimulation device 100-1 may be disassembled by separating one type of stimulation head 102-1 from the handle 101 and the handle and another type of stimulation head 102-2 shown in FIG. 3B can be assembled into another type of sexual stimulation device 100-2 shown in FIG. 1B. Although FIGS. 1A-1D show four different types of sexual stimulation device assemblies 100-1, 100-2, 100-3, 100-4, types of the Sexual stimulation device 100 are not limited thereto and any other compatible modules or stimulation heads 102 may be included in the Sexual stimulation device. (not shown in drawings.)

In one example, a user may hold the handle 101 with one hand and remove or attach a stimulation head 102 from or to the handle with another hand. The user may manipulate the Sexual stimulation device 100 by holding the handle 101 to apply the Sexual stimulation device to a body part. The user may turn on the stimulation of the Sexual stimulation device 100 before or after positioning the Sexual stimulation device at or in a desired body part. The user may turn of the stimulation of the Sexual stimulation device 100 while the Sexual stimulation device is located at or in a body part. Controlling mechanisms are disclosed below.

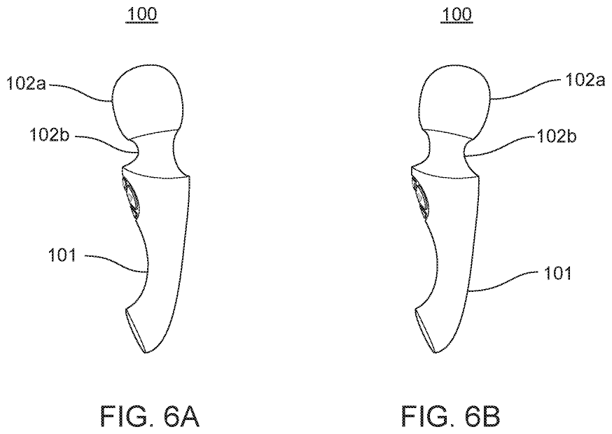

Referring to FIG. 2, in some embodiment, the handle 101 has a bottom portion that is wider than a top portion. In some embodiment, the handle 101 has a bottom portion that is narrower than a top portion, as exemplified in FIGS. 6A and 6B. In some embodiments, referring to FIGS. 6A-8B, the handle 101 is ergonomically shaped or curved for comfortable grip by a user. In some embodiments, control button(s) 105 are located on the wider top portion of the handle 101 for easy access by the user, as exemplified in FIGS. 6A-8B.

In some embodiments, the handle 101 houses electronic components and battery and goes through all the compliance certifications. In some embodiments, substantially all or all of the electronic components are in the handle 101 except for the stimulator component such as a vibration and/or suction motor provided in the stimulation head 102. In some embodiments, the stimulation head 102 includes a single stimulator component capable of generating various types of stimulation. In some embodiments, the stimulation head 102 includes multiple stimulator components, each stimulator component capable of generating a different type of stimulation. Thus, the handle 101 has the ability to operate the stimulation heads 102 that provide different types of stimulation, for example, vibration, thrusting, warming, and/or electro-stimulation via a single or multiple stimulator component(s). Further, in some embodiments, the handle 101 has the ability to detect which type of stimulation head 102 is fitted when the handle 101 and the stimulation head 102 are coupled. For example, this is achieved by a two-wire communications link, which implements a custom messaging protocol between the handle 101 and stimulation head 102 to interrogate what stimulation head 102 is attached and to send the motor data to the stimulation head 102 to drive vibrations. In some embodiments, each stimulation head 102 contains an active micro controller for motor operation.

Further, in some embodiments, the handle 101 includes support for status indication such as full Red, Green and Blue (RGB) status indication, providing visual feedback to the user that the stimulation head 102 is fitted to the handle 101 correctly. For example, the RGB status indication provides a visual or colored indicator of which stimulation head 102 is fitted. The indication also provides visual feedback of which pattern ID is in operation, charge levels, Bluetooth® connection, and/or battery status.

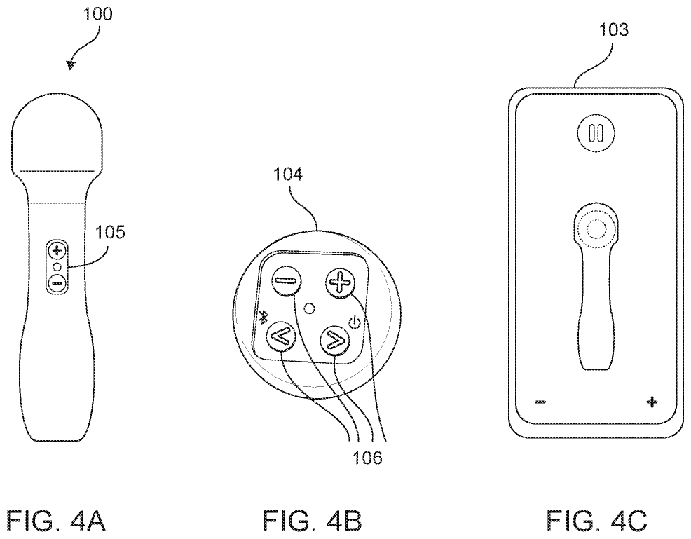

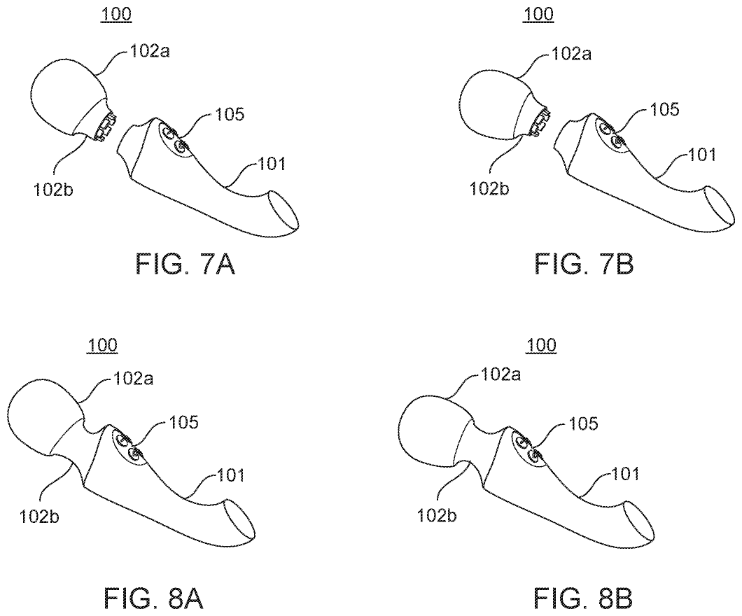

In some embodiments, the handle 101 includes a port, for example, micro USB port, for USB charging with built-in rechargeable battery. For example, the battery provides 1 hour of run time from full charge. The handle 101 is provided with control button(s) 105, for example, 2 buttons as exemplified in FIG. 2 or 4 buttons provided on the side of the unit in a 2×2 pattern array, as exemplified in FIGS. 7A-8B. These provide functions such as power on/off, stimulation pattern navigation, intensity adjustment, and Bluetooth pairing (for App control). For example, the handle 101 is provided with a Bluetooth® chipset to allow for Smart App control 103 exemplified in FIG. 4C. In some embodiments, various stimulation patterns are programmed via the control button(s) 105 such that different stimulation patterns are generated in sequence.

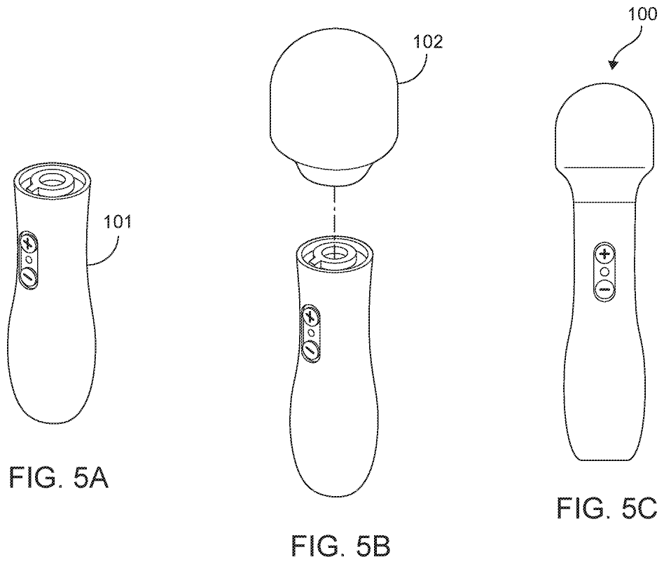

FIGS. 3A-3D show multiple stimulation heads 102-1, 102-2, 102-3, and 102-4 that are attached to the top of the handle 101 to create different form-factor Sexual stimulation devices 100. Waterproof and shock-absorbing connection mechanism is provided, as exemplified in FIGS. 5A-5C, for attaching the stimulation heads 102 to the handle 101 in a fully sealed way to deliver waterproof functionality. In some embodiments, an electrical interface is provided between the handle 101 and stimulation head 102 to achieve sufficient waterproofing rating. Thus, the assembled Sexual stimulation device 100 is waterproof, allowing cleaning of the stimulation head 102 whether removed from or attached to handle 101. High quality, high power stimulation components like stimulation motors are provided in all the stimulation heads 102 and they are powered by the battery in the handle 101.

By attaching various types of stimulation heads 102 to the handle 101, the Sexual stimulation device 100 may be used to stimulate various sexual organs of male or female users. For example, various stimulation heads 102-1, 102-2, 102-3, 102-4 shown in FIGS. 3A-3D can be used for different purposes. However, the stimulation heads 102 are not limited to the ones 102-1, 102-2, 102-3, 102-4 shown in FIGS. 3A-3D, and additional types of stimulation heads 102 may be available or become available. For example, manufacturers may make new types of stimulation head 102 available in the future. Each of the various stimulation heads 102-1, 102-2, 102-3, 102-4 is provided with stimulation components like vibration or suction motors. In some embodiments, a stimulation head 102 has a vibration motor, a suction motor, or a vibration and suction motor. Each of the stimulation heads 102-1, 102-2, 102-3, 102-4 has a different shape. For example, the stimulation head 102-1 having a vibration motor is shaped and configured to stimulate the clitoris, the stimulation head 102-2 having a vibration motor is shaped and configured to stimulate the labia, the stimulation head 102-3 having a suction and vibration motor is shaped and configured to stimulate the G-spot and clitoris at the same time, and the stimulation head 102-4 having a suction and vibration motor is shaped and configured to stimulate penis.

For example, referring to FIG. 3A, the stimulation head 102-1 is conical but flaring at the broad end, having a void space formed centrally by a wall. In some embodiments, the stimulation head 102-1 is a labia vibrator. In some embodiments, the stimulation head 102-1 contacts the labia majora and stimulates through vibration around the edges of the wider part of the flared head.

For example, referring to FIG. 3B, the stimulation head 102-2 includes a cylindrical bottom portion extending to a hemispherical top portion. In some embodiments, as shown in FIGS. 7A and 7B, the bottom portion 102b of the stimulation head 102-2 is asymmetrically shaped. Thus, the top potion 102a of the stimulation head 102-2 is angled with respect to the handle 101 when the stimulation head 102-2 is coupled to the handle 101, as exemplified in FIGS. 6A, 6B, 8A, and 8B. The asymmetric stimulation head 102-2 can be fitted in alternative positions on the handle 101 to suit comfort of the user such that the stimulation head 102-2 is flipped based on the orientation of the attachment. That is, the bottom portion 102b of the stimulation head 102-2 is attachable to the handle 101 in various orientations, as exemplified in FIGS. 7A and 7B. For example, when the bottom portion 102b of the stimulation head 102-2 is coupled to the handle 101 in a first orientation, as shown in FIG. 7A, the top portion 102a of the stimulation head 102-2 is tilted toward a first direction, as shown in FIG. 8A. Further, when the bottom portion 102b of the stimulation head 102-2 is coupled to the handle 101 in a second orientation, as shown in FIG. 7B, the top portion 102a of the stimulation head 102-2 is tilted toward a second direction that is different from the first direction, as shown in FIG. 8B. In some embodiments, the hemispherical top portion of the stimulation head 102-2 contacts the clitoris to provide vibration thereto.

For example, referring to FIG. 3C, stimulation head 102-3 has a base portion that is similar to the shape of the stimulation head 102-1 shown in FIG. 3A and a rod portion extending centrally from the base portion. In some embodiments, the rod portion of the stimulation head 102-3 is elongated such that the rod portion can be inserted into the vagina to provide vibration to the G-spot while the flared base portion of the stimulation head 102-3 is placed over the labia. In some embodiments, the base portion of the stimulation head 102-3 contacts the labia majora and stimulates through vibration around the edges of the wider part of the flared base portion.

For example, referring to FIG. 3D, the stimulation head 102-4 has a base portion and a pipe portion widening from the base portion, the pipe portion including an opening. In some embodiments, the pipe portion of the stimulation head 102-4 is angled with respect to the base portion such that the base portion of the stimulation head 102-4 contacting the handle 101 extends vertically along the length direction of the handle 101 and the pipe portion extends curvingly from the base portion. In some embodiments, the angle between the base portion and the pipe portion of the stimulation head 102-4 is between 90° and 180°, between 100° and 170°, between 110° and 160°, between 120° and 150°, or between 130° and 140°. In some embodiments, at least the head portion of the penis is inserted into the opening of the stimulation head 102-4 such that vibration and/or suction is provided to the penis.

In some embodiments, the pattern and/or strength of stimulation are different based on the type of the stimulation head 102 attached to the handle 101. In some embodiments, the stimulation components like vibrating motor(s) can be individually controlled, and a stimulation pattern includes up to 5 minutes of unique pattern sequencing of the motors before repeating. In some embodiments, users can create their own stimulation patterns utilizing the App available on Google Play and Apple App store. Once created, these patterns can be loaded onto the Sexual stimulation device 100 for use in standalone operation mode.

In some embodiments, the handle 101 also has a stimulation component like vibrating motor. In other embodiments, the handle 101 does not have a stimulation component like vibrating motor. In some embodiments, the sexual stimulation device 100 can be powered on only when the stimulation head 102 is coupled to the handle 101, the stimulation component of the stimulation head powered by the battery in the handle.

Referring to FIGS. 4A and 4B, the Sexual stimulation device 100 can be controlled with a stand-alone simultaneous, multi-device controller remote 104 that works with all the stimulation heads 102, one at a time and many at once. In some embodiments, USB charging can be performed with built-in battery rechargeable via a micro USB port of the remote 104. It may provide up to 1 hour of use from full charge. The controller remote 104 is provided with control buttons 106. For example, 4 buttons are provided on the remote 104 in a 2×2 pattern array. These provide functions such as power on/off, stimulation pattern navigation, and intensity adjustment. In some embodiments, various stimulation patterns/intensities are programmed via the control button(s) 105 such that different stimulation patterns/intensities are generated in sequence.

In some embodiments, the remote 104 is waterproof. In some embodiments, the remote 104 is 100% waterproof. Simultaneous, multi-device controller remote 104 works with all the stimulation heads 102 individually as well as many at once. Further, in some embodiments, the Sexual stimulation device 100 can also be controlled with an application or app 103 installed on a smart phone, as shown in FIG. 4C. Furthermore, in some embodiments, the Sexual stimulation device 100 shown in FIG. 4A has its own control button(s) 105 located on side(s) of the handle housing 101.

FIGS. 5A-5C show a connection mechanism between the handle 101 and the stimulation head 102. In some embodiments, the connection mechanism includes waterproof and shock-absorbing connection mechanism. The stimulation heads 102 can be connected to the handle 101 in a fully sealed way to deliver waterproof functionality. In some embodiments, the shock-absorbing element is located in the handle 101 and/or the stimulation head 102. In some embodiments, the shock absorbing element is located in the stimulation head 102 having a mechanical action such as vibration and/or thrusting. That is, in some embodiments, vibration isolation between vibrating stimulation head 102 and handle 101 is achieved within the attached stimulation head 102, thus preventing vibrations transferring into the user's hand holding the handle 101. In some embodiments, the stimulation head 102 is detached from the handle 101 by simply being pulled away from the handle and coupled to the handle by simply being pushed into a receiving portion of the handle. In some embodiments, the stimulation head 102 and the handle 101 are coupled and fastened by having threaded fasteners. In some embodiments, the stimulation head 102 and the handle 101 are coupled and fastened by having twist-lock, such as a quarter turn lock, or a slide-lock. Further, high quality, high power stimulation components like stimulation motors are provided in all the stimulation heads 102. Stimulation components like stimulation head motor(s) can be individually controlled, and a stimulation pattern may consist of up to 5 minutes of unique pattern sequencing of the motors before repeating. Users can create their own stimulation patterns utilising the smart phone App available on Google Play and Apple App store. Once created, these patterns can be loaded onto the Sexual stimulation device 100 for use in standalone operation mode.

According to various embodiments of the present disclosure, a modular sexual stimulation device includes a handle and at least one replaceable/detachable stimulation head. The handle is configured to receive at least one stimulation head.

According to some embodiments of the present disclosure, the handle includes a built-in battery. In some embodiments, the handle further includes a port coupled to the battery. In some embodiments, the port is configured to receive a cable configured to be coupled to an electrical power outlet such that the battery can be recharged. In some embodiments, the handle includes at least one control button. In some embodiments, the at least one control button is used for controlling at least one of power on/off of the device, stimulation pattern navigation, intensity adjustment, or BLUETOOTH pairing with an external device. In some embodiments, the device is configured to provide various preset stimulation patterns such that a user can select a desired one of the preset stimulation patterns via the at least one control button. In some embodiments, the preset stimulation patterns are programmable by the user. In some embodiments, the device is controllable via an application running on a mobile device that is configured to communicate with the device wirelessly. In some embodiments, the device is waterproof by having a waterproof and shock-absorbing connection mechanism for coupling the at least one stimulation head to the handle. In some embodiments, the at least one stimulation head includes at least two different types of heads such that the handle can be coupled to any one of the at least two different types of stimulation heads. In some embodiments, each of the at least two different types of stimulation heads has its own stimulation components like a vibrating motor. In some embodiments, the stimulation components are powered by a battery enclosed in the handle. In some embodiments, the device further includes a remote control module configured to control at least one of power on/off of the device, stimulation pattern navigation, or intensity adjustment.

According to various embodiments of the present disclosure, a modular Sexual stimulation device includes a handle enclosing at least a rechargeable battery and a first stimulation head configured to be detached from or coupled to the handle. The first stimulation head encloses a first stimulation component like a vibrating motor that is powered by the battery.

According to some embodiments of the present disclosure, the further includes a second stimulation head configured to be detached from or coupled to the handle such that the first stimulation head can be replaced with the second stimulation head. In some embodiments, the second stimulation head encloses a second stimulation component like a vibrating motor that is powered by the battery. In some embodiments, the first stimulation head and the second stimulation head have different shapes. In some embodiments, the device further includes a control button for controlling the first stimulation head and the second stimulation head. In some embodiments, the device can be powered on in response to user input received via the control button, a remote-control module, or an application installed at an external device only when the first stimulation head or the second stimulation head is coupled to the handle.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A modular sexual stimulation device comprising:
a handle; and
at least one replaceable/detachable stimulation head,
wherein the handle is configured to receive the at least one stimulation head.

2. The device according to claim 1, wherein the at least one stimulation head is asymmetrically shaped and configured to be coupled to the handle in at least two different orientations such that the at least one stimulation head points toward a different direction based on a coupling orientation.

3. The device according to claim 2, wherein the handle includes a built-in battery and/or a port coupled to the battery.

4. The device according to claim 3, wherein the port is configured to receive a cable configured to be coupled to an electrical power outlet such that the battery can be recharged.

5. The device according to claim 1, wherein the handle includes at least one control button.

6. The device according to claim 5, wherein the at least one control button is used for controlling at least one of power on/off of the device, stimulation pattern navigation, intensity adjustment, or BLUETOOTH pairing with an external device.

7. The device according to claim 5, wherein the device is configured to provide various preset stimulation patterns such that a user can select a desired one of the preset stimulation patterns via the at least one control button.

8. The device according to claim 7, wherein the preset stimulation patterns are programmable by the user.

9. The device according to claim 1, wherein the device is controllable via an application running on a mobile device that is configured to communicate with the device wirelessly.

10. The device according to claim 1, wherein the device is waterproof by having a waterproof and shock-absorbing connection mechanism for coupling the at least one stimulation head to the handle.

11. The device according to claim 1, wherein the at least one stimulation head includes at least two different types of stimulation heads such that the handle can be coupled to any one of the at least two different types of stimulation heads.

12. The device according to claim 11, wherein each of the at least two different types of stimulation heads has its own stimulation component.

13. The device according to claim 12, wherein the stimulation component is powered by a battery enclosed in the handle and includes one or more of a vibration and/or suction motor, a thrusting component, a warming component, and an electro-stimulation component.

14. The device according to claim 1, further comprising a remote control module configured to control at least one of power on/off of the device, stimulation pattern navigation, or intensity adjustment.

15. A modular sexual stimulation device comprising:
a handle enclosing at least a rechargeable battery; and
a first stimulation head configured to be detached from or coupled to the handle,
wherein the first stimulation head encloses a first vibration and/or suction motor and/or one or more components capable of causing thrusting, warming, and/or electro-stimulation that is powered by the battery.

16. The device according to claim 15, further comprising a second stimulation head configured to be detached from or coupled to the handle such that the first stimulation head can be replaced with the second stimulation head.

17. The device according to claim 16, wherein the second stimulation head encloses a second vibration and/or suction motor and/or one or more components capable of causing thrusting, warming, and/or electro-stimulation that is powered by the battery.

18. The device according to claim 16, wherein each of the first stimulation head and the second stimulation head has a different shape and configured to stimulate a different sexual organ of a user or subject.

19. The device according to claim 16, further comprising a control button for controlling the first stimulation head and the second stimulation head.

20. The device according to claim 19, wherein the device can be powered on in response to user input received via the control button, a remote control module, or an application installed at an external device only when the first stimulation head or the second stimulation head is coupled to the handle.
